(19) United States
(12) Patent Application Publication
(10) Pub. No.: US 2011/0047049 A1
(43) Pub. Date: Feb. 24, 2011

(54) Business operation service system and method thereof

(75) Inventor: Chun-Hsu Su, Taipei City (TW)

Correspondence Address: ROGER H. CHU, 19499 ERIC DRIVE, SARATOGA, CA, 95070, US

(73) Assignee: AmRoad Technology, Inc., Taipei County (TW)

(21) Appl. No.: 12/543,493

(22) Filed: Aug. 18, 2009

(51) Int. Cl. G06Q 30/00; G06Q 10/00; G06Q 20/00

(52) U.S. Cl. 705/27.1; 705/30; 705/26.25

(57) ABSTRACT

In a business operation service system and a method applied in an environment of a video phone service platform, a middleware of software/hardware of a Fixed-Mobile Convergency (FMC) handheld communication device is provided for users to enter a telephone number to enter a specific interactive screen by dialing a telephone number and/or a string of numbers and/or a string of words to connect a telephone to complete a connection. Users can use a Session Initiation Protocol (SIP) of the FMC handheld communication device to browse the specific interactive screen containing business information, a commercial service and/or a product trading provided by the system and the method of the invention to purchase a product, inquire business information and/or obtain a commercial service. Since the business operation service system and its method only provide a specific licensed service, a service charge can be collected from users through the dialing registration process.

### BACKGROUND OF THE INVENTION

1. Field of the Invention

The present invention generally relates to a business operation service technique, and more particularly to a business operation service system and a business operation service method applied in an environment of a video phone service platform, wherein a user enters into an interactive screen by dialing a telephone number, so that the user can use a mobile phone for purchasing a product and/or inquiring business information and/or obtaining a commercial service through a session initiation protocol (SIP). The business operation service system and the method thereof provide a specific licensed service only, and thus a service charge can be collected during a dialing registration process made by the user via a phone.

2. Description of the Related Art

In the present e-shopping environment, users can perform a purchase transaction from a product provider's website via the Internet by using a computer and a browser.

However, this purchasing mode usually has the following problems. The network may be unable to start an interactive trade timely due to busy data transmissions, or both buyer and seller cannot identify each other easily, or the trading cash flow has a low security, or the credit card information may be stolen by an unauthorized party easily, or the cash flow detail cannot be obtained, or the quality of products cannot be assured, or both parties cannot interact with each other timely.

In the television shopping environment, users can purchase a product from a shopping channel by using a television and a telephone.

However, such shopping mode still has some problems, such as the products are sold in a certain specific time period, and users cannot purchase a product whose information is displayed in audio and video forms, if the users miss such particular selling time period, or users are limited to the time period and the location of a television for the purchase and cannot shop anytime or anywhere.

Therefore, it is an important subject for related sellers to find feasible solutions for the aforementioned problems of the network shopping and television shopping, so that users can shop anytime and anywhere.

### SUMMARY OF THE INVENTION

The primary objective of the present invention is to provide a business operation service system and its method applied in an environment of a video phone service platform, such a consumer end can use a fixed-mobile convergency (FMC) handheld communication device or a video phone to browse an interactive screen containing business information and/or commercial services and/or product trading through the business operation service system and the method thereof by a session initiation protocol (SIP) in accordance with the present invention, so that users can use a video phone to purchase a product in a consuming process and/or inquire business information and/or obtain a commercial service.

Another objective of the present invention is to provide a business operation service system and its method applied in an environment of an FMC handheld communication device or a video phone service platform, for providing a specific licensed service, so that a telecommunication company can collect a service charge from a consumer end (or a user) through a dialing registration process.

A further objective of the present invention is to provide a business operation service system and its method applied in an environment of an FMC handheld communication device or a video phone service platform, such that users can use the FMC handheld communication device to purchase a product through a session initiation protocol (SIP) to assure the security of both parties who make and receive payments via SIP, provide the details of a cash flow, and reduce the possibility of committing frauds.

Another objective of the present invention is to provide a business operation service system and its method applied in an environment of an FMC handheld communication device or a video phone service platform that provides a 24-hour service of providing an interactive screen containing business information and/or commercial service and/or product trading without worrying about a disconnection of communication, provided that users have passed the authentication procedure specified by a seller end.

To achieve the foregoing objectives, the present invention provides a business operation service system and a method thereof, the business operation service system comprises a user's processing module, a data/information providing module, and a data/information processing module. Since the business operation service system and its method of the invention only provide a specific licensed service, so that a service can be collected from a consumer end (or a user) during a dialing registration process.

The user's processing module is provided for processing and recording a data transmitted from a consumer end, using the data as a basis for collecting the service charge, and recording all registration information of a seller end.

The data/information providing module is used for providing a specific licensed service to transmit a specific interactive screen to the consumer end and a screen of an FMC handheld communication device at the seller end.

The data/information processing module is used for receiving and processing related data/information (for purchasing a product and/or inquiring business information and/or obtaining a commercial service) selected by the consumer end, and carrying out a corresponding follow-up action, wherein the FMC handheld communication device can be any handheld device with a video communication function such as a mobile phone, a personal digital assistant (PDA) or a mobile phone having a video function, and the business operation service system may or may not include a financial processing mechanism, depending on the actual implementations and situations.

When the business operation service system of the invention is used for carrying out the method of the business operation service, a middleware of software/hardware of the FMC handheld communication device is used for transmitting a telephone number and/or a string of numbers and/or a string of words required for the registration to the user's processing module directly by a telephone number dialing method at a consumer end, and the user's processing module is provided for processing the dialing registration at the consumer end, and recording the registration for collecting a service charge at a later stage.

After the user has registered through the user's processing module, the data/information providing module will provide a specific licensed service through a telecommunication company, and a specific interactive screen will show the business information and/or commercial service and/or product trading on a screen of a FMC handheld communication device at a consumer end to achieve the effect of directly using the method of dialing a telephone number and/or a string of numbers and/or a string of words to connect the FMC handheld communication device, so as to enter into the specific interactive screen to complete the connection. The consumer end uses a session initiation protocol (SIP) of the FMC handheld communication device to browse the specific interactive screen containing the business information and/or commercial service and/or product trading provided by the business operation service system and its method of the present invention, and users can purchase a product and/or inquire business information and/or obtain a commercial service through an interactive screen containing the business information and/or commercial service and/or product trading provided by the data/information providing module of the business operation service system via the screen of the FMC handheld communication device.

The telecommunication company transmits related data/information of the purchase of product and/or business information inquiry and/or commercial service selected by the consumer end from the FMC handheld communication device to the data/information processing module.

Finally, after the data/information processing module of the business operation service system has received the related data/information of the purchase of product and/or business information inquiry and/or commercial service selected by the consumer end, the related data/information is processed and a corresponding follow-up action is taken place. For example, after the data/information processing module has processed the related data/information, a cash flow data/information corresponding to the data/information is transmitted to a financial processing mechanism for handling a financial transaction such as a mechanism of enhancing the security of both trading parties during the process of ISP's account receivable and accounting, a complete listing of cash flow details, and a measure of reducing the possibility of frauds.

The business operation service method carried out by the business operation service system in accordance with the present invention comprises the following steps: A consumer end and a seller end register through a telecommunication company, and then the seller end registers through a business operation service system, and the consumer end selects and logs on a business operation service system by (1) directly connecting to the telecommunication company by inputting data from a video phone at the consumer end, and then the telecommunication company determines whether or not the consumer end has registered, or (2) connecting to a business operation service system and transmitting a business catalog screen to the consumer end after using an FMC handheld communication device at a consumer end to directly connect to the business operation service system and transmit the business catalog screen and select the way of logon, and then the consumer end selects a desired seller end, and the business operation service system connects the seller end through the telecommunication company for dialing a number to the seller end, and the consumer end can communicate and confirm a desired service with the seller end through an interactive screen, and finally the consumer end makes payment.

To make it easier for our examiners and persons skilled in the art to understand the objects, characteristics and performance of the present invention, preferred embodiments and related drawings are used for the detailed description of the present invention as follows:

### BRIEF DESCRIPTION OF THE DRAWINGS

FIG. 1 is a schematic view of operations of instant interactive services provided by a business operation service system in accordance with the present invention;

FIG. 2 is a schematic view of a system architecture of a business operation service system and operations conducted by the business operation service system, a mobile phone, a phone telecommunication company, and a cash flow processing mechanism in accordance with the present invention;

FIG. 3 is a flow chart of a business operation service method performed by the business operation service system of the invention as depicted in FIG. 2;

FIG. 4 is another flow chart of a business operation service method performed by the business operation service system of the invention as depicted in FIG. 2; and

FIGS. 5-1 and 5-2 show a flow chart of a business operation service method in accordance with a preferred embodiment of the present invention.

### DETAILED DESCRIPTION OF THE PREFERRED EMBODIMENTS

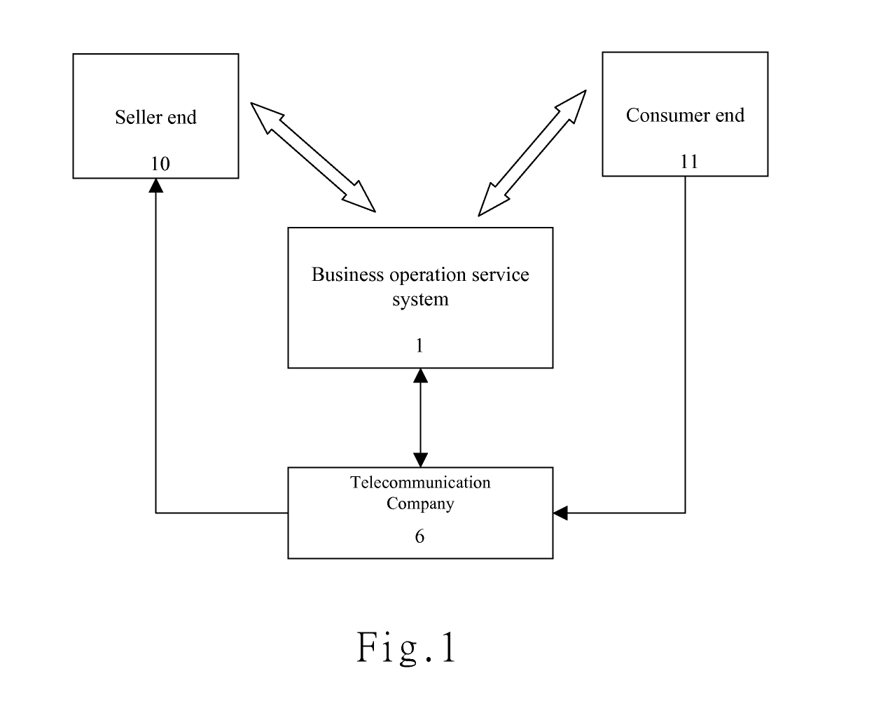

With reference to FIG. 1 for a schematic view of a system architecture of a business operation service system, the operation of an instantaneous interactive service provided by the present invention is described as follows. A consumer end 11 and a seller end 10 are required to register to a telecommunication company 6 first. Since this model is well developed, both parties can register conveniently, and all required data have been established by the telecommunication company 6, and the seller end 10 simply needs to register by entering required data to the business operation service system 1, and the consumer end 11 simply needs to dial a specific number or enter a specific text or a string of numbers from a video phone to connect the telecommunication company 6. After the connection is made, the business operation service system 1 will show a screen containing business information, commercial service and product trading on a screen of the video phone at the consumer end 11. After an item is selected, the telecommunication company 6 will dial a number to the seller end 10 and then transmit an instantaneous interactive video to the seller end 10 and the consumer end 11 for a business transaction.

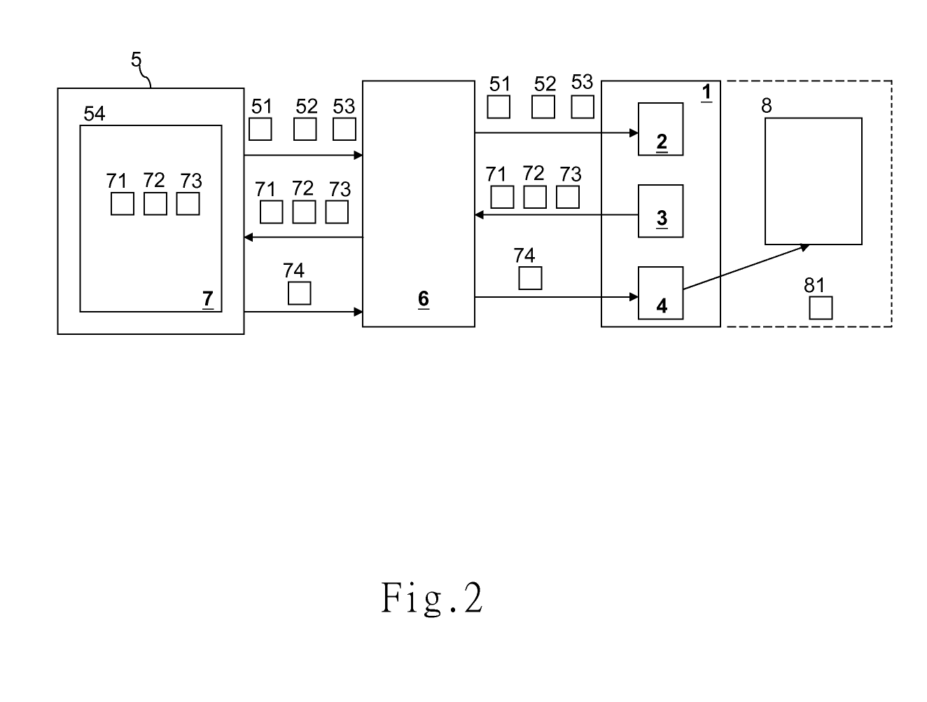

With reference to FIG. 2 for a schematic view of a system architecture of a business operation service system and operations of the business operation service system with an FMC handheld communication device, a telecommunication company and a cash flow processing mechanism in accordance with the present invention, the business operation service system 2 comprises a user's processing module 2, a data/information providing module 3, and a data/information processing module 4. Since the business operation service system 1 of the invention just provides a specific licensed service, and thus a service charge can be collected from the user during the dialing registration process.

The user's processing module 2 is used for processing and recording data transmitted from the consumer end, and the data is used as a basis for collecting a service charge from the consumer end and recording all information registered by a seller end. With the action of a middleware (not shown in the figure) of software/hardware of the FMC handheld communication device 5, a user can use the FMC handheld communication device 5 such as a mobile phone with a video function to directly transmit a telephone number 51 and/or a string of numbers 52 and/or a string of words 53 required for the registration to the user's processing module 2 by dialing a telephone number. The user's processing module 2 is provided for processing the dialing registration process at the consumer end 11 and recording the registration as a basis of collecting a service charge of the financial processing mechanism 8 at a later stage. The business operation service system 1 may or may not include a financial processing mechanism 8, depending on actual implementation and situations.

The data/information providing module 3 is used for providing a specific licensed service, and transmitting the specific interactive screen to screens of the FMC handheld communication devices at the consumer end and the seller end. After the consumer end 11 of the user's processing module 2 has registered, the data/information providing module 3 only provides the specific licensed service, and the telecommunication company 6 will show a specific interactive screen 7 containing business information 71 and/or commercial service 72 and/or product trading 73 at a screen 54 of the FMC handheld communication device 5 at the consumer end 11 to achieve the effect of connecting the FMC handheld communication device 5 directly by dialing a telephone number 51 and/or a string of numbers 52 and/or a string of words 53 to enter into the specific interactive screen 7 and complete the connection. The consumer end 11 uses a session initiation protocol (SIP) of the FMC handheld communication device 5 to browse the specific interactive screen 7, and the consumer end 11 can use the interactive screen 7 shown on the screen of the FMC handheld communication device 5 to purchase a product and/or inquire business information and/or obtain a commercial service (not shown in the figure). The session initiation protocol (SIP) can be divided into three layers, wherein the highest layer is a telecommunication company or an operator such as ChungHwa Telecom or any other telecommunications integrators; the second layer is a service provider such as Mackay Telecommunications and SKYPE; and the third layer is a carrier.

The data/information processing module 4 is used for receiving and processing related data/information (including a purchase of a product and/or a business information inquiry and/or a commercial service) selected by the consumer end to perform a corresponding follow-up action. After the consumer end 11 uses a specific interactive screen 7 shown on a screen 54 of the FMC handheld communication device 5 to purchase a product and/or inquire business information and/or obtain a commercial service, the FMC handheld communication device 5 and the telecommunication company 6 transmit the related data/information 74 of the purchase of product and/or business information inquiry and/or commercial service selected by the consumer end 11 to the data/information processing module 4. After the data/information processing module 4 has received the related data/information 74, the related data/information 74 is processed to carry out a corresponding follow-up action (not shown in the figure). For example, after the data/information processing module 4 has processed the related data/information 74, a cash flow data/information 81 corresponding to the data/information 74 is transmitted to a financial processing mechanism 8 for handling a financial transaction, so as to achieve the effects of improving the security of both trading parties through an ISP account receivable and accounting, completely listing the details of a cash flow, and lowering the probability of committing frauds.

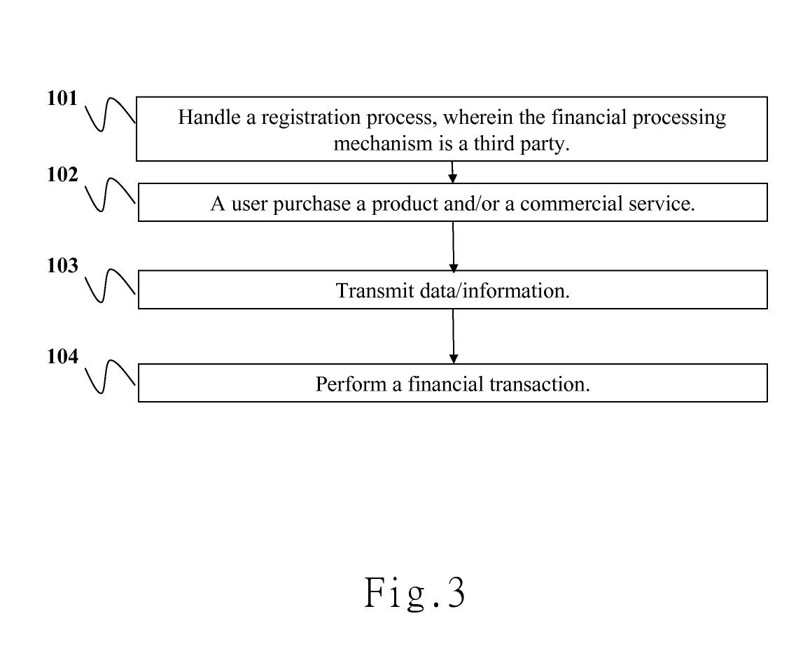

With reference to FIG. 3 for a flow chart of a business operation service method performed by the business operation service system of the invention as depicted in FIG. 2, a middleware (not shown in the figure) of software/hardware of an FMC handheld communication device 5 is used in Step 101, so that a user can directly use the FMC handheld communication device 5 to dial a number to transmit a telephone number 51 and/or a string of numbers 52 and/or a string of words 53 required for a registration to the user's processing module 2. The user's processing module 2 is used for processing the user's dialing registration process and recording the registration as a basis for collecting a service charge of a financial processing mechanism 8 at a later stage. The business operation service system 1 does not include a financial processing mechanism 8 which is a third party, and then the procedure goes to Step 102.

In Step 102, after the user of the user's processing module 2 has registered, the data/information providing module 3 only provides a specific licensed service, and the mobile phone telecommunication company 6 shows a specific interactive screen 7 containing business information 71 and/or a commercial service 72 and/or a product trading 73 on a screen 54 of the user's video phone 5, and the user uses the interactive screen 7 shown on the screen 54 of the video phone 5 to perform a purchase of product and/or a business information inquiry and/or obtain a commercial service (not shown in the figure), and then the procedure goes to Step 103.

In Step 103, the related data/information 74 of the purchase of product and/or business information inquiry and/or commercial service selected by the user is transmitted from the FMC handheld communication device 5 and the telecommunication company 6 to the data/information processing module 4, and then the procedure goes to Step 104.

In Step 104, after the data/information processing module 4 has received and processed the related data/information 74, a corresponding follow-up action (not shown in the figure) will take place. For example, cash flow data/information 81 corresponding to the data/information 74 is transmitted to the financial processing mechanism 8 to handle a financial transaction after the data/information processing module 4 has processed the related data/information 74, so that the security of a transaction between two trading parties is improved by the ISP account receivable and accounting, and a cash flow detail is listed completely, and the probability of committing frauds is lowered.

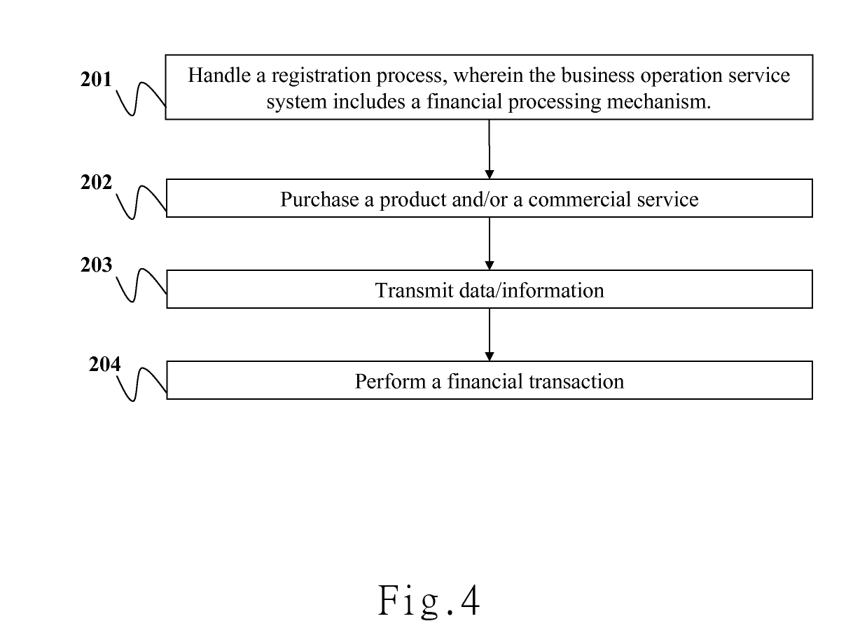

With reference to FIG. 4 for another flow chart of a business operation service method performed by the business operation service system of the invention as depicted in FIG. 2, a middleware (not shown in the figure) of software/hardware of an FMC handheld communication device 5 is used in Step 201, so that a user can directly use the FMC handheld communication device 5 to dial a number to transmit a telephone number 51 and/or a string of numbers 52 and/or a string of words 53 required for a registration to the user's processing module 2. The user's processing module 2 is used for processing the user's dialing registration process and recording the registration as a basis for collecting a service charge of a financial processing mechanism 8 at a later stage. The business operation service system 1 includes a financial processing mechanism 8, and then the procedure goes to Step 202.

In Step 202, after the user of the user's processing module 2 has registered, the data/information providing module 3 only provides a specific licensed service, and the mobile phone telecommunication company 6 shows a specific interactive screen 7 containing business information 71 and/or a commercial service 72 and/or a product trading 73 on a screen 54 of the user's video phone 5, and the user uses the interactive screen 7 shown on the screen 54 of the video phone 5 to perform a purchase of product and/or a business information inquiry and/or obtain a commercial service (not shown in the figure), and then the procedure goes to Step 203.

In Step 203, the related data/information 74 of the purchase of product and/or business information inquiry and/or commercial service selected by the user is transmitted from the FMC handheld communication device 5 and the telecommunication company 6 to the data/information processing module 4, and then the procedure goes to Step 204.

In Step 204, after the data/information processing module 4 has received and processed the related data/information 74, a corresponding follow-up action (not shown in the figure) will take place. For example, cash flow data/information 81 corresponding to the data/information 74 is transmitted to the financial processing mechanism 8 to handle a financial transaction after the data/information processing module 4 has processed the related data/information 74, so that the security of a transaction between two trading parties is improved by the ISP account receivable and accounting, a cash flow detail is listed completely, and the probability of committing frauds is lowered.

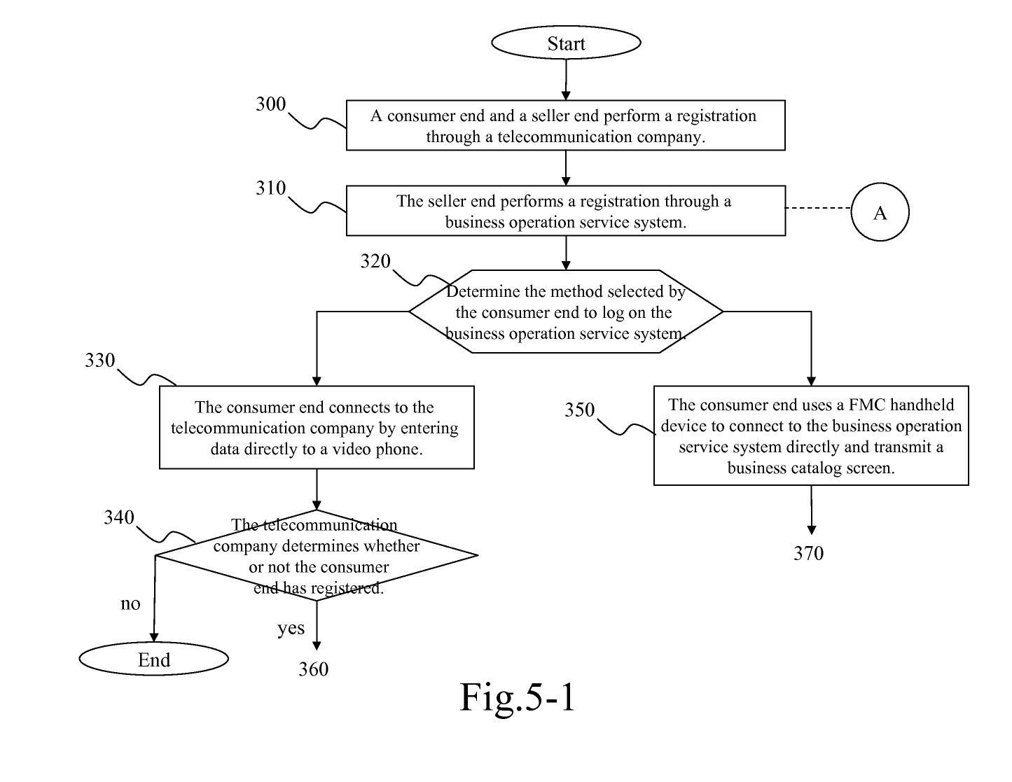

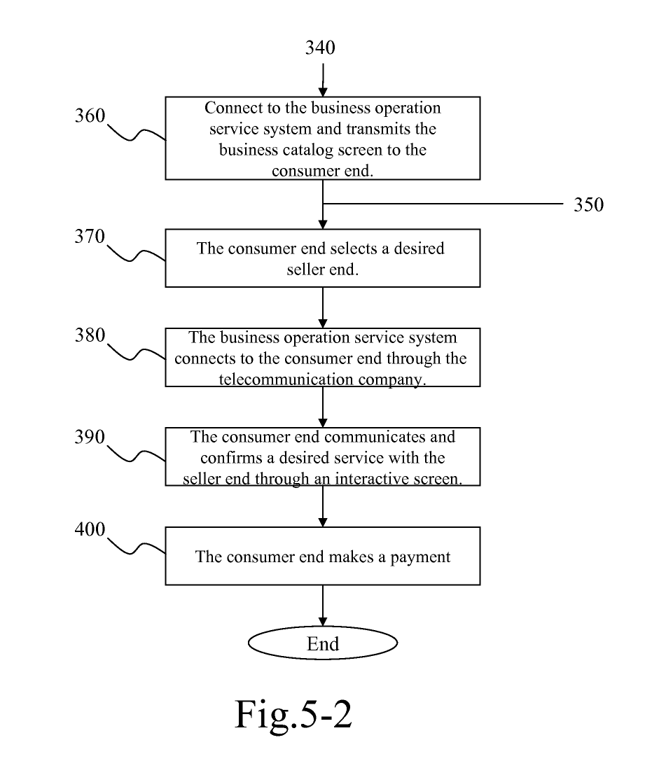

With reference to FIGS. 5-1 and 5-2 for a flow chart of a business operation service method in accordance with a preferred embodiment of the present invention, a consumer end 11 and a seller end 10 perform a registration through a telecommunication company 6 (Step 300), and both consumer end 11 and seller end 10 are FMC handheld communication devices, and the registration data inputted by the consumer end 11 and the seller end 10 comprises a name, an ID, an address and a telephone number. After the registration is completed, the seller end 10 performs a registration through a business operation service system 1 (Step 310). The registered seller end 10 needs to create a file for describing the selling products and classification for a business operation service system 1, and such registration mode has been well developed in the e-shopping operation, and thus will not be described here. The consumer end 10 selects a method of logging in the business operation service system 1 (Step 320), and two methods as described below may be used. In the first method, the consumer end 11 connects to the telecommunication company 6 by directly entering data into a video phone (Step 330), and the method of inputting data through the video phone can be done by selectively entering a telephone number, a string of numbers and a string of words. Then the telecommunication company 6 determines whether or not the consumer end 11 has registered (Step 340). If the consumer end 11 has not registered, the consumer end 11 will be requested to register first, and then this procedure will end. If the consumer end 11 has registered, then the business operation service system 1 will be connected to transmit a business catalog screen to the consumer end 11 (Step 360). In the second method, the consumer end 11 uses an FMC handheld communication device to directly connect to the business operation service system 1 and transmit a business catalog screen (Step 350), wherein the business catalog comprises a business information and a commercial service. Regardless of which method is sued for logging in the business operation service system 1, the consumer end 11 needs to select a desired seller end 10 (Step 370). After the selection is made, the business operation service system 1 will be connected to the seller end 10 through the telecommunication company 6 (Step 380), and then the consumer end 11 will communicate and confirm a required service with the seller end 10 through the interactive screen (Step 390), and finally the consumer end 11 makes a payment (Step 400), and then this procedure will end.

In Step 380, a number is dialed directly to the seller end 10 through the telecommunication company 6 according to the data registered by the seller end 10.

In Step 400, a service charge is collected from the consumer end 11 through a merged telephone bill of the telecommunication company 6.

In summation of the aforementioned preferred embodiments of the invention, we can obtain a business operation service system and its method applied in an environment of a video phone service platform, wherein a middleware of a video phone software/hardware is used for allowing a user to dial a telephone number to enter into a specific interactive screen, and directly connect a telephone by dialing a telephone number and/or a string of numbers, so as to enter into the specific interactive screen to complete a connection. The user can use a session initiation protocol (SIP) of the video phone to browse the specific interactive screen containing business information and/or commercial service and/or product trading provided by a business operation service system and its method in accordance with the present invention, so that the user can use a mobile phone to purchase a product and/or inquire a business information inquiry and/or obtain a commercial service. The business operation service system and its method of the invention only provide a specific licensed service, and thus the user's dialing registration process can be used for collecting a service charge. In summation, the business operation service system and its method in accordance with the present invention includes the following advantages:
1. Users use the session initiation protocol (SIP) of the video phone to browse the interactive screen containing the business information and/or commercial service and/or product trading provided by the business operation service system and the method of the invention, so that users can use a mobile phone to purchase a product and/or inquire business information and/or obtain a commercial service.
2. A specific license service is provided, so that the user's dialing registration process through a mobile phone can be used for collecting the service charge from users.
3. Users uses the session initiation protocol (SIP) of the video phone to purchase a product, so that the invention can achieves the effects of improving the security of both trading parties during the process of ISP's account receivable and accounting, and providing a complete list of cash flow details and a measure of reducing the possibility of frauds.
4. Only users who pass through an authentication procedure provided by a specific company can use the screen containing the related information, wherein an interactive screen containing the business information and/or commercial service and/or product trading is provided 24 hours a day, without the worry of a communication disconnection.

While the invention has been described by means of specific embodiments, numerous modifications and variations could be made thereto by those skilled in the art without departing from the scope and spirit of the invention set forth in the claims.

What is claimed is:

1. A business operation service method, applied in an environment of a video phone service platform, and the business operation service method comprising the steps of:
directly dialing a number through a video telephone at a consumer end to transmit a telephone number and/or a string of numbers and/or a string of words;
processing a dialing registration process of the consumer end, and recording the registration as a basis for collecting a service charge of a financial processing mechanism at a later stage;
providing a specific licensed service only after the registration process is completed, and a telecommunication company showing a specific interactive screen containing business information and/or commercial service and/or product trading on a screen of an FMC handheld communication device;
using the specific interactive screen to perform the purchase of product and/or business information inquiry and/or commercial service by the consumer end;
transmitting related data/information of the purchase of product and/or business information inquiry and/or commercial service selected at the consumer end; and
processing and performing a corresponding follow-up action after the related data/information is received.

2. The business operation service method of claim 1, wherein the financial processing mechanism is a third party.

3. The business operation service method of claim 1, wherein the corresponding follow-up action is to transmit cash flow data/information of the related data/information to the financial processing mechanism for handling a financial transaction.

4. The business operation service method of claim 3, wherein the financial transaction is an ISP account receivable and accounting.

5. A business operation service method, applied in an environment of a video phone service platform, and the business operation service method comprising the steps of:
using a middleware of software/hardware of an FMC handheld communication device by a consumer end to directly dial a number of a video telephone for transmitting a telephone number and/or a string of numbers and/or a string of words required for a registration to a user's processing module;
the user's processing module processing the dialing registration process at the consumer end, and recording the registration process as a basis for collecting a service charge for a financial processing mechanism at a later stage;
the data/information providing module providing a specific licensed service only after the registration process is completed, and the telecommunication company showing a specific interactive screen containing business information and/or commercial service and/or product trading on a screen of an FMC handheld communication device;
using the specific interactive screen at the consumer end to perform a purchase of product and/or a business information inquiry and/or a commercial service;
the FMC handheld communication device and the telecommunication company transmitting related data/information of the purchase of product and/or business information inquiry and/or commercial service selected at the consumer end to the data/information processing module; and
processing the related data/information and performing a corresponding follow-up action after the data/information processing module has received the related data/information.

6. The business operation service method of claim 5, wherein the financial processing mechanism is a third party.

7. The business operation service method of claim 5, wherein the corresponding follow-up action is transmitting cash flow data/information corresponding to the related data/information of the data/information processing module to a financial processing mechanism for handling a financial transaction.

8. The business operation service method of claim 7, wherein the financial transaction is an ISP account receivable and accounting.

9. A business operation service system, applied in an environment of a video phone service platform, and the business operation service system comprising:
a user's processing module, for processing data transmitted from a consumer end, recording the data as a basis for collecting a service charge at a later stage and recording all information registered at a seller end;
a data/information providing module, for providing a specific licensed service, and transmitting a specific interactive screen to screens of FMC handheld communication devices at the consumer end and the seller end; and
a data/information processing module, for receiving related data/information including a purchase of product and/or a business information inquiry and/or a commercial service selected at the consumer end, and performing a corresponding follow-up action.

10. The business operation service system of claim 9, further comprising a financial processing mechanism for collecting a service charge.

11. The business operation service system of claim 9, wherein the corresponding follow-up action refers to the data/information processing module transmitting cash flow data/information of the related data/information to a financial processing mechanism for handling a financial transaction.

12. The business operation service system of claim 11, wherein the financial transaction is an ISP account receivable and accounting.

13. A business operation service method, applied in an environment of a video phone service platform, and the business operation service method comprising the steps of:
a consumer end and a seller end performing a registration through a telecommunication company;
the seller end performing a registration through a business operation service system;
the consumer end selecting a method of logging in the business operation service system;
the consumer end directly connecting to the telecommunication company by a method of inputting data into a video phone;
the telecommunication company determining whether or not the consumer end has registered;
connecting to the business operation service system and transmitting a business catalog screen to the consumer end;
the consumer end selecting a desired seller end;
the business operation service system connecting to the seller end through the telecommunication company;
the consumer end communicating and confirming a required service with the seller end through an interactive screen; and
the consumer end making a payment.

14. The business operation service method of claim 13, wherein the consumer end and the seller end are FMC handheld communication devices.

15. The business operation service method of claim 13, wherein the method of inputting data through a video phone selectively enters a telephone number, a string of numbers and a string of words.

16. The business operation service method of claim 13, wherein the business catalog comprises business information and a commercial service.

17. The business operation service method of claim 13, wherein the consumer end and the seller end enters a registration data comprising a name, an ID, an address and a telephone number.

18. The business operation service method of claim 13, wherein the business operation service system connects to the seller end through the telecommunication company according to the data registered by the seller end and directly dialed to the seller end.

19. The business operation service method of claim 13, wherein the consumer end makes a payment according to a merged telephone bill of the telecommunication company and the payment is collected directly at the consumer end.

20. A business operation service method, applied in an environment of a video phone service platform, and the business operation service method comprising the steps of:
a consumer end and a seller end performing a registration through a telecommunication company;
the seller end performing a registration through a business operation service system;
the consumer end determining a method to log on the business operation service system;
the consumer end using an FMC communication device to directly connect to the business operation service system and transmitting a business catalog screen;
the telecommunication company determining whether or not the consumer end has registered;
connecting to the business operation service system and transmitting the business catalog screen to the consumer end;
the consumer end selecting a desired seller end;
the business operation service system connecting to the seller end through the telecommunication company;
the consumer end communicating and confirming a required service with the seller end through an interactive screen; and
the consumer end making a payment.

21. The business operation service method of claim 20, wherein the business catalog comprises business information and a commercial service.

22. The business operation service method of claim 20, wherein the consumer end and the seller end enters registration data comprising a name, an ID, an address and a telephone number.

23. The business operation service method of claim 20, wherein the business operation service system connects to the seller end through the telecommunication company according to the data registered by the seller end and directly dialed to the seller end.

24. The business operation service method of claim 20, wherein the consumer end makes a payment according to a merged telephone bill of the telecommunication company and the payment is collected directly at the consumer end.
